(19) United States
(12) Patent Application Publication
(10) Pub. No.: US 2026/0227871 A1
(43) Pub. Date: Aug. 6, 2026

(54) TOUCH CIRCUIT AND TOUCH SENSING DEVICE

(71) Applicant: HOSEO UNIVERSITY ACADEMIC COOPERATION FOUNDATION, Asan-si, Chungcheongnam-do (KR)

(72) Inventors: Byung Seong BAE, Asan-si, Chungcheongnam-do (KR); Seo Jin KANG, Siheung-si, Gyeonggi-do (KR); Hyuck Su LEE, Incheon (KR); Jang Hoo LEE, Seongnam-si, Gyeonggi-do (KR)

(73) Assignee: HOSEO UNIVERSITY ACADEMIC COOPERATION FOUNDATION, Asan-si, Chungcheongnam-do (KR)

(21) Appl. No.: 19/149,424

(22) PCT Filed: Feb. 9, 2023
(86) PCT No.: PCT/KR2023/001943

§ 371 Date: Jul. 18, 2025

(30) Foreign Application Priority Data
Feb. 7, 2023 (KR) 10-2023-0016419

(51) Int. Cl. G06F 3/041; G06F 3/044

(52) U.S. Cl. CPC G06F 3/0416; G06F 3/044

(57) ABSTRACT

The present invention relates to a touch circuit for stably maintaining an output voltage level by using a transistor, comprising: a first drive transistor (T1) having a drain electrode and a gate electrode connected to input power source (VDD), and having a source electrode connected to the drain electrode of a second drive transistor (T2); and the second drive transistor (T2) having the gate electrode connected to one electrode of a capacitor of which the other electrode is connected to the input power source (VDD), having the drain electrode connected to the source electrode of the first drive transistor (T1), and having the source electrode connected to the ground.

### TECHNICAL FIELD

The present disclosure relates to a touch circuit and a touch sensing device. In particular, the present disclosure relates to a touch circuit and a touch sensing device capable of providing a reliable output in response to a touch.

### BACKGROUND ART

A touch sensor refers to a technology that is used in a touch panel or a touch screen and receives input directly through a user's touch. Such touch sensors are applied to various display products, such as smartphones, tablet personal computers (PCs), notebook PCs, all-in-one (AIO) PCs, and digital information displays (DIDs), and to other fields beyond information technology (IT) products, including the automotive market.

Touch sensors are utilized in various fields, such as automated teller machines and digital door locks, and capacitive circuits configured in compact form are also applied to fingerprint recognition. Touch sensor technology employs multifunctional fusion/composite structures that incorporate single-electrode-layer touch sensors, flexible touch sensors, embedded touch sensors, large-area touch sensors, fingerprint recognition sensors, and digitizers.

As the ability to detect touch has been increasingly enhanced and technologies such as fingerprint recognition have become widely used, touch sensors that can be used as general touch sensors have been proposed. However, the reliability and accuracy of the sensor may decrease as the distance between the sensor and the touch increases.

### DISCLOSURE

### Technical Problem

The present disclosure is directed to providing a touch circuit and a touch sensing device capable of securing stability and reliability so as to operate normally even when a distance between a sensor and a touch position increases.

### Technical Solution

To achieve the above objective, according to the present disclosure, there is provided a touch circuit for stably maintaining an output voltage level using transistors, the touch circuit including: a first driving transistor (T1) having a drain electrode and a gate electrode connected to an input power supply (VDD), and having a source electrode connected to a drain electrode of a second driving transistor (T2); and the second driving transistor (T2) having a gate electrode connected to one electrode of a capacitor, and having the drain electrode connected to the source electrode of the first driving transistor (T1), and having a source electrode connected to ground, the capacitor having another electrode connected to the input power supply (VDD).

In addition, according to the present disclosure, there is provided a touch circuit for stably maintaining an output voltage level using transistors, the touch circuit including: a first driving transistor (T1) having a drain electrode and a gate electrode connected to a source electrode of a third driving transistor (T3), and having a source electrode connected to a drain electrode of a second driving transistor (T2); the second driving transistor (T2) having a gate electrode connected to one electrode of a capacitor, and having the drain electrode connected to the source electrode of the first driving transistor (T1), and having a source electrode connected to ground, the capacitor having another electrode connected to an input power supply (VDD); the third driving transistor (T3) having a drain electrode and a gate electrode connected to the input power supply (VDD), and having the source electrode connected to the drain electrode and the source electrode of the first driving transistor (T); and a fourth driving transistor (T3) having a gate electrode connected to the gate electrode of the second driving transistor (T2), and having a drain electrode connected to the drain electrode of the first driving transistor (T1), and having a source electrode connected to the ground.

Preferably, the touch circuit may further include a fifth driving transistor (T5) having a gate electrode connected to the drain electrode of the second driving transistor (T2), and having a source electrode connected to the gate electrode of the second driving transistor (T2), and having a drain electrode connected to the input power supply (VDD).

Preferably, the first driving transistor (Il) to the fourth driving transistor (T4) may be n-channel MOSFETs, and the fifth driving transistor (T5) may be a p-channel MOSFET.

Preferably, the touch circuit may further include a sixth driving transistor (T6) having a drain electrode connected to the gate electrode of the second driving transistor (T2), and having a gate electrode connected to the drain electrode of the second driving transistor (T2), and having a source electrode connected to the ground.

In addition, according to the present disclosure, there is provided a touch sensing device for stably maintaining an output voltage level using transistors, the touch sensing device including: a first driving transistor (T1) having a drain electrode and a gate electrode connected to an input power supply (VDD), and having a source electrode connected to a drain electrode of a second driving transistor (T2); the second driving transistor (T2) having a gate electrode connected to one electrode of a capacitor, and having the drain electrode connected to the source electrode of the first driving transistor (T1), and having a source electrode connected to ground, the capacitor having another electrode connected to the input power supply (VDD); a touch electrode connected to the gate electrode of the second driving transistor (T2); and an output stage connected to the drain electrode of the second driving transistor (T2), wherein when the touch electrode is not touched, a voltage of the output stage becomes a voltage close to the ground, or when the touch electrode is touched, the voltage of the output stage becomes a voltage close to the input power supply (VDD).

### Advantageous Effects

According to the present disclosure, when a node voltage of a touch portion changes to the ground level due to a touch, the ground level can be stably maintained using the transistors.

In addition, according to the present disclosure, the output can be stably maintained at the ground level by using the transistors while there is no touch.

In addition, according to the present disclosure, the output can be stably maintained at the input power supply level by using the transistors while there is a touch.

In addition, according to the present disclosure, a signal is stabilized during a touch, thereby providing robustness against noise.

### DESCRIPTION OF DRAWINGS

FIG. 1 illustrates a basic circuit diagram of a touch circuit according to an embodiment of the present disclosure.

FIG. 2 illustrates a circuit diagram of a touch circuit in which transistors (T3 and T4) are added to the circuit shown in FIG. 1 in order to stably maintain the output at the ground level when a touch occurs, according to an embodiment of the present disclosure.

FIG. 3 illustrates a circuit diagram of a touch circuit in which a transistor (T5) is added to the circuit shown in FIG. 1 in order to stably maintain a node voltage of a touch portion at the input power supply level when there is no touch, according to an embodiment of the present disclosure.

FIG. 4 illustrates a circuit diagram of a touch circuit in which transistors (T3, T4, and T5) are added to the circuit shown in FIG. 1 in order to have all the advantages shown in FIGS. 2 and 3, according to an embodiment of the present disclosure.

FIG. 5 illustrates a circuit diagram of a touch circuit in which a transistor (T6) is added to the circuit shown in FIG. 1 in order to stably maintain a node voltage of a touch portion at a ground level when a touch occurs, according to an embodiment of the present disclosure.

FIG. 6 illustrates a circuit diagram of a touch circuit in which transistors (T5 and T6) are added to the circuit shown in FIG. 1 in order to have all the advantages shown in FIGS. 3 and 5, according to an embodiment of the present disclosure.

FIG. 7 illustrates a circuit diagram of a touch circuit in which transistors (T3, T4, T5, and T6) are added to the circuit shown in FIG. 1 in order to have all the advantages shown in FIGS. 1 to 6, according to an embodiment of the present disclosure.

### BEST MODE

Hereinafter, the present disclosure will be described in detail with reference to the accompanying drawings. However, the present disclosure is not limited or restricted by exemplary embodiments thereof. The same reference numerals shown in the drawings indicate members that perform substantially the same function. Terms, such as first, second, and the like, used in the specification can be used to describe various elements, but the elements are not to be construed as being limited to the terms.

The present disclosure may be embodied in various other forms without departing from the technical idea or essential characteristics thereof. Therefore, embodiments of the present disclosure are merely exemplary in all respects and should not be construed as limiting.

The terms are only used to differentiate one element from other elements. For example, a first element may be named a second element without departing from the scope of the present disclosure, and a second element may also be similarly named a first element.

It will be understood that when an element is referred to as being “coupled” or “connected” to another element, it can be directly coupled or connected to the other element or intervening elements may be present therebetween.

In contrast, it will be understood that when an element is referred to as being “directly coupled” or “directly connected” to another element, there are no intervening elements present.

The terms used in the present specification are merely used to describe particular embodiments, and are not intended to limit the present disclosure. An expression used in the singular encompasses the expression of the plural, unless it has a clearly different meaning in the context.

In the present specification, it is to be understood that terms such as “including”, “provided with”, and “having” are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, the most preferred embodiments of the present disclosure will be described in detail with reference to the accompanying drawings in order to describe the present disclosure in sufficient detail to enable those skilled in the art to which the present disclosure pertains to easily embody the present disclosure.

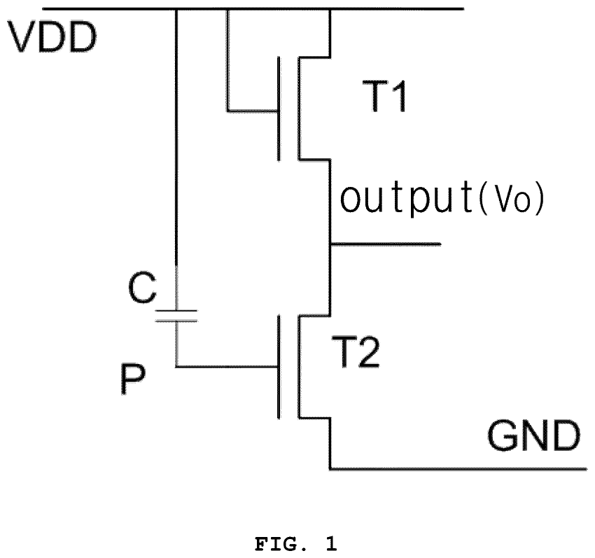

FIG. 1 illustrates a basic circuit diagram of a touch circuit according to an embodiment of the present disclosure. As shown in FIG. 1, in order to stably maintain an output voltage level using transistors, a touch circuit may include a first driving transistor (T1), a second driving transistor (T2), and a capacitor (C). The touch circuit may be implemented such that the first driving transistor (T1) and the second driving transistor (T2) are N-type metal-oxide-semiconductor field-effect transistors (MOSFETs).

According to the embodiment shown in FIG. 1, the first driving transistor (Tl) may have a drain electrode and a gate electrode connected to the input power supply (VDD), and may have a source electrode connected to a drain electrode of the second driving transistor (T2). The second driving transistor (T2) may have a gate electrode connected to one electrode of the capacitor, the other electrode of which is connected to the input power supply (VDD), may have the drain electrode connected to the source electrode of the first driving transistor (T1), and may have a source electrode connected to the ground.

In the touch circuit according to the embodiment shown in FIG. 1, the capacitor (C) may be disposed between the input power supply (VDD) and the second driving transistor (T2). The touch circuit may be configured such that the capacitance of the capacitor (C) is set greater than the parasitic capacitance Cgs between the gate electrode and the source electrode of the second driving transistor (T2), so that the voltage (Vp) at point P when there is no touch is made close to the input power supply (VDD). Specifically, voltage Vp at point P is determined by Vp=VDD*C/(Cgs+C), and as C increases relative to Cgs, voltage Vp at point P approaches VDD. Herein, the touch circuit may output a low voltage (Vo) close to the ground voltage, with the first driving transistor (T1) and the second driving transistor (T2) turned on.

The touch circuit may be configured such that when a touch occurs, the parasitic capacitance Cgs between the gate electrode and the source electrode of the second driving transistor (T2) increases to be greater than the capacitance of the capacitor (C) and the voltage (Vp) at point P is close to the ground voltage. Herein, the touch circuit may output a high voltage close to the input voltage (VDD), with the first driving transistor (T1) remaining turned on and the second driving transistor (T2) turned off. In this way, the touch circuit may determine whether there is a touch or not through the output voltage.

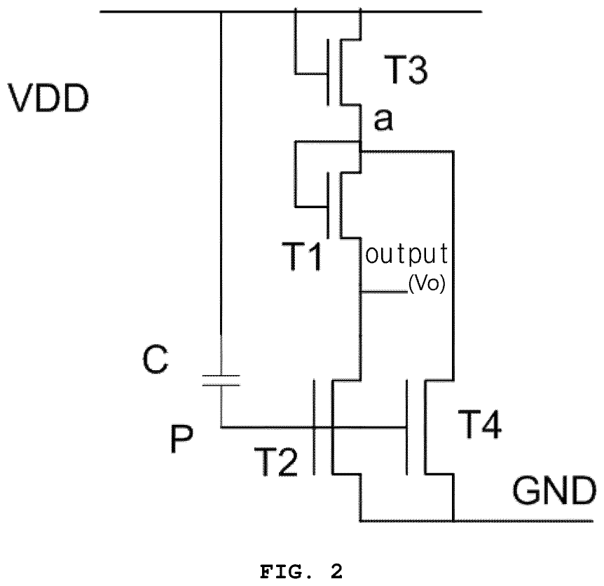

FIG. 2 illustrates a circuit diagram of a touch circuit in which transistors (T3 and T4) are added to the circuit shown in FIG. 1 in order to stably maintain the output at the ground level when a touch occurs, according to an embodiment of the present disclosure. As shown in FIG. 2, in order to stably maintain an output voltage level using transistors, a touch circuit may include a first driving transistor (T1), a second driving transistor (T2), a third driving transistor (3), a fourth driving transistor (14), and a capacitor (C). The touch circuit may be implemented such that the first driving transistor (T1) to fourth driving transistor (T4) are N-type MOSFETs.

According to the embodiment shown in FIG. 2, the first driving transistor (T1) may have a drain electrode and a gate electrode connected to a source electrode of the third driving transistor (T3), and may have a source electrode connected to a drain electrode of the second driving transistor (T2). The second driving transistor (T2) may have a gate electrode connected to one electrode of the capacitor, the other electrode of which is connected to the input voltage (VDD), may have the drain electrode connected to the source electrode of the first driving transistor (T1), and may have a source electrode connected to the ground.

The third driving transistor (T3) may have a drain electrode and a gate electrode connected to the input voltage (VDD), and may have a source electrode connected to the drain electrode of the first driving transistor (T1), and the drain electrode of the fourth driving transistor (T4). The fourth driving transistor (T4) may have a gate electrode connected to a gate electrode of the second driving transistor (T2), may have a drain electrode connected to the drain electrode of the first driving transistor (T1), and may have a source electrode connected to the ground.

In the touch circuit according to the embodiment shown in FIG. 2, when there is no touch, the voltage (Vp) at point P becomes the input power supply (VDD), so the input power supply (VDD) is applied to the gate electrode of the fourth driving transistor (T4) and the fourth driving transistor (T4) is turned on. Accordingly, the touch circuit may lower the voltages of the gate electrode of the first driving transistor (T1) and the drain electrode of the first driving transistor (T1), that are connected to the drain electrode of the fourth driving transistor (T4), to the ground voltage. Therefore, the touch circuit may more stably maintain the output voltage (Vo) at the ground potential level.

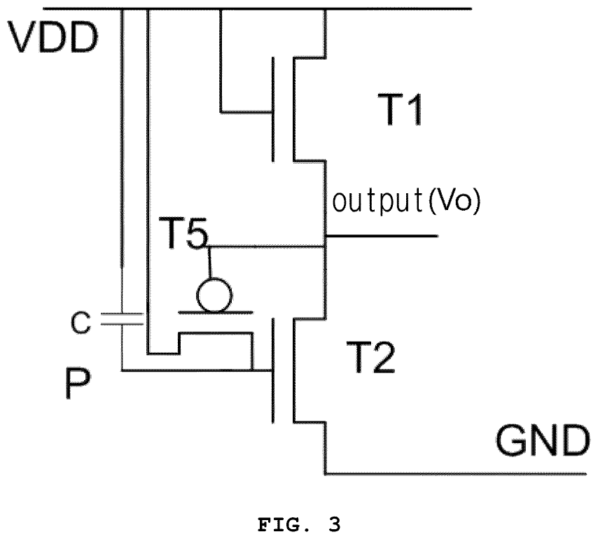

FIG. 3 illustrates a circuit diagram of a touch sensor circuit in which a transistor (T5) is added to the circuit shown in FIG. 1 in order to stably maintain a node voltage of a touch portion at the input power supply level when there is no touch, according to an embodiment of the present disclosure. As shown in FIG. 3, in order to stably maintain an output voltage level using transistors, a touch circuit may include a first driving transistor (T1), a second driving transistor (T2), a fifth driving transistor (T5), and a capacitor (C). The touch circuit may be implemented such that the first driving transistor (T1) and the second driving transistor (T2) are N-type MOSFETs and the fifth driving transistor (T5) is a P-type MOSFET.

In the embodiment shown in FIG. 3, the first driving transistor (T1) and the second driving transistor (T2) have the same connection relationship as in FIG. 1. The fifth driving transistor (T5) may have a gate electrode connected to a drain electrode of the second driving transistor (T2), may have a source electrode connected to a gate electrode of the second driving transistor (T2), and may have a drain electrode connected to the input voltage (VDD).

In the touch circuit according to the embodiment shown in FIG. 3, when there is no touch, the voltage (Vp) at point P becomes the input power supply (VDD), so the second driving transistor (T2) is turned on. Accordingly, in the touch circuit, the ground voltage is applied to the gate electrode of the fifth driving transistor (15) connected to the drain electrode (output stage) of the second driving transistor (T2), so the fifth driving transistor (T5) is turned on. Therefore, the touch circuit may more stably maintain the voltage (Vp) at point P at the input voltage (VDD) level. In the touch circuit, when a touch occurs, the input voltage (VDD) is applied to the gate electrode of the fifth driving transistor (T5), so the fifth driving transistor (15) is turned off and does not affect the voltage (Vp) at point P.

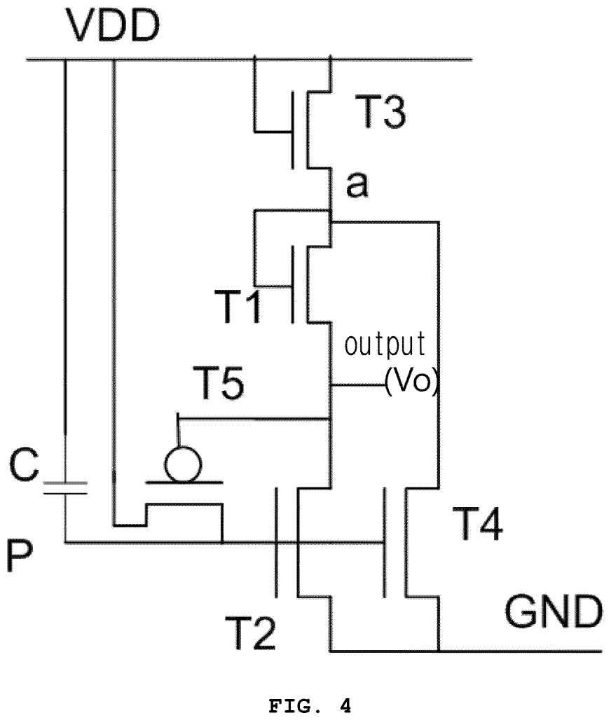

FIG. 4 illustrates a circuit diagram of a touch sensor circuit in which transistors (T3, T4, and T5) are added to the circuit shown in FIG. 1 in order to have all the advantages shown in FIGS. 2 and 3, according to an embodiment of the present disclosure. As shown in FIG. 4, in order to stably maintain an output voltage level using transistors, a touch circuit may include a first driving transistor (T1) to a fifth driving transistor (T5), and a capacitor (C). The touch circuit may be implemented such that the first driving transistor (T1) to the fourth driving transistor (T2) are N-type MOSFETs and the fifth driving transistor (T5) is a P-type MOSFET.

In the embodiment shown in FIG. 4, the first driving transistor (T1) to the fourth driving transistor (T4) have the same connection relationship as in FIG. 2, and the fifth driving transistor (T5) has the same connection relationship as in FIG. 3.

In the touch circuit according to the embodiment shown in FIG. 4, when there is no touch, the output voltage (Vo) may be stabilized to the ground voltage level by the fourth driving transistor (T4) (the principle is the same as in FIG. 2). In addition, in the touch circuit, the fifth driving transistor (T5) is turned on and the voltage (Vp) at point P may be stabilized to the input voltage (VDD) level (the principle is the same as in FIG. 3).

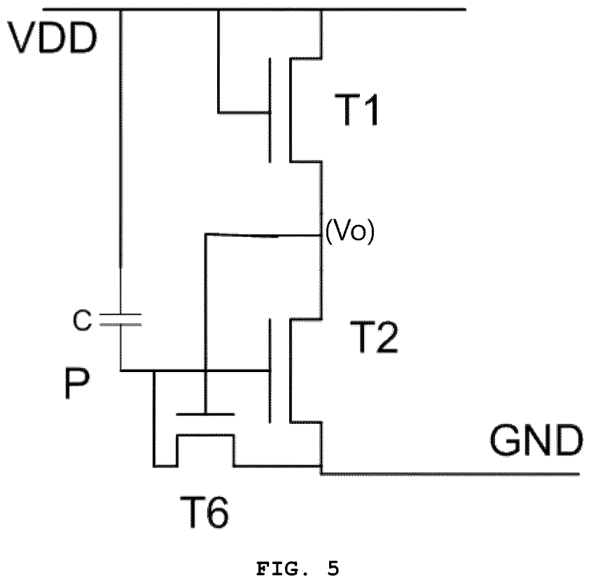

FIG. 5 illustrates a circuit diagram of a touch sensor circuit in which a transistor (T6) is added to the circuit shown in FIG. 1 in order to stably maintain a node voltage of a touch portion at a ground level when a touch occurs, according to an embodiment of the present disclosure. As shown in FIG. 5, in order to stably maintain an output voltage level using transistors, a touch circuit may include a first driving transistor (T1), a second driving transistor (T2), a sixth driving transistor (T6), and a capacitor (C). The touch circuit may be implemented such that the first driving transistor (T1), the second driving transistor (T2), and the sixth driving transistor (T6) are N-type MOSFETS.

In the embodiment shown in FIG. 5, the first driving transistor (T1) and the second driving transistor (T2) have the same connection relationship as in FIG. 1. The sixth driving transistor (T6) may have a drain electrode connected to a gate electrode of the second driving transistor (T2), may have a gate electrode connected to a drain electrode of the second driving transistor (T2), and may have a source electrode connected to the ground.

In the touch circuit according to the embodiment shown in FIG. 5, when there is no touch, the voltage (Vp) at point P becomes the input power supply (VDD) and the output voltage (Vo) becomes the ground voltage, so the ground voltage is applied to the gate electrode of the sixth driving transistor (T6) connected to the drain electrode (output stage) of the second driving transistor (T2). Therefore, in the touch circuit, the sixth driving transistor (16) is turned off and does not affect the voltage (Vp) at point P.

In the touch circuit, when a touch occurs, the voltage (Vp) at point P decreases and the output voltage (Vo) becomes close to the input voltage (VDD), so the input voltage (VDD) is applied to the gate electrode of the sixth driving transistor (T6). Therefore, in the touch circuit, the sixth driving transistor (T6) is turned on and the voltage (Vp) at point P may be stabilized to the ground voltage level.

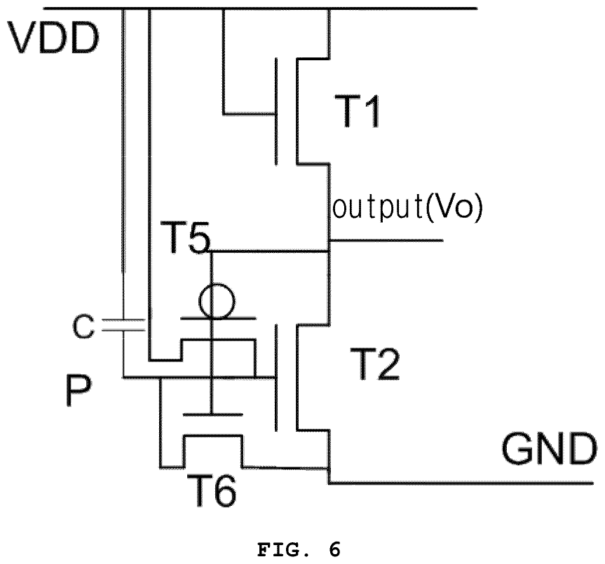

FIG. 6 illustrates a circuit diagram of a touch sensor circuit in which transistors (T5 and T6) are added to the circuit shown in FIG. 1 in order to have all the advantages shown in FIGS. 3 and 5, according to an embodiment of the present disclosure. As shown in FIG. 6, a first driving transistor (T1), a second driving transistor (T2), a fifth driving transistor (T5), a sixth driving transistor (T6), and a capacitor (C) may be included. The touch circuit may be implemented such that the first driving transistor (T1), the second driving transistor (T2), and the sixth driving transistor (T6) are N-type MOSFETs and the fifth driving transistor (T5) is a P-type MOSFET.

In the embodiment shown in FIG. 6, the first driving transistor (Tl), the second driving transistor (T4), and the sixth driving transistor (T6) have the same connection relationship as in FIG. 5, and the fifth driving transistor (T5) has the same connection relationship as in FIG. 3.

In the touch circuit according to the embodiment shown in FIG. 6, when there is no touch, the fifth driving transistor (15) is turned on and the voltage (Vp) at point P may be more stably maintained at the input voltage (VDD) level. Herein, the sixth driving transistor (T6) remains in the off state. In the touch circuit, when a touch occurs, the sixth driving transistor (T6) is turned on and the voltage (Vp) at point P may be stabilized to the ground voltage level.

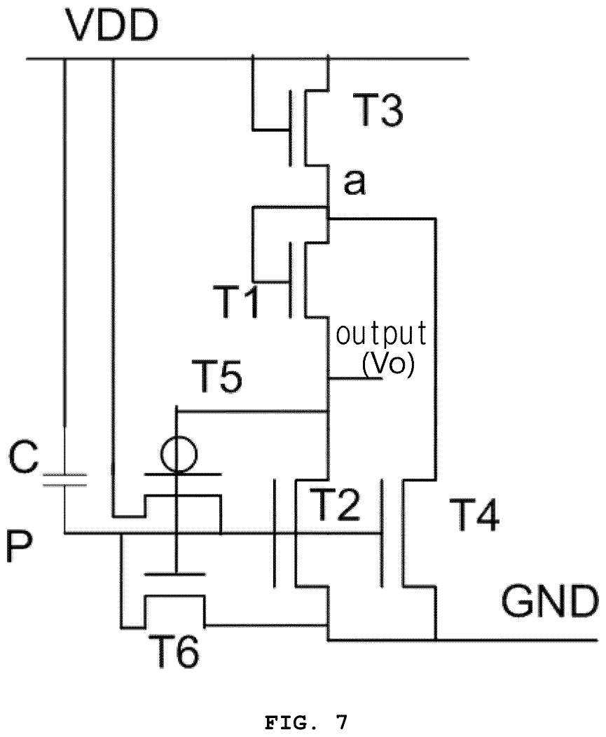

FIG. 7 illustrates a circuit diagram of a touch sensor circuit in which transistors (T3, T4, 15, and T6) are added in order to have all the advantages shown in FIGS. 1 to 6, according to an embodiment of the present disclosure. As shown in FIG. 7, a first driving transistor (T1) to a sixth driving transistor (T6), and a capacitor (C) may be included. £ The touch circuit may be implemented such that the first driving transistor (T1) to the fourth driving transistor (T4), and the sixth driving transistor (16) are N-type MOSFETs and the fifth driving transistor (T5) is a P-type MOSFET.

In the embodiment shown in FIG. 7, the first driving transistor (T1) to the fifth driving transistor (T5) have the same connection relationship as in FIG. 4, and the sixth driving transistor (T6) has the same connection relationship as in FIG. 5.

In the touch circuit according to the embodiment shown in FIG. 7, when there is no touch, the fifth driving transistor (T5) is turned on and the sixth driving transistor (T6) is turned off and the voltage (Vp) at point P may be more stably maintained at the input voltage (VDD) level. In addition, in the touch circuit, when there is no touch, the fourth driving transistor (T4) is turned on, so the voltage at point a is lowered to the ground voltage and the output voltage (Vo) may be stabilized to the ground voltage level.

In the touch circuit, when a touch occurs, the second and the fourth driving transistors (T2, T4) are turned off and the output voltage (Vo) increases. Accordingly, the fifth driving transistor (T5) is turned off, the sixth driving transistor (T6) is turned on, and the voltage (Vp) at point P may be stabilized to the ground voltage level.

A touch sensing device according to another embodiment of the present disclosure includes the touch circuit described above, and may further include a touch electrode connected to the gate electrode of the second driving transistor (T2) and an output stage connected to the drain electrode of the second driving transistor (T2). In the touch sensing device, when the touch electrode is not touched, the voltage of the output stage may become the voltage close to the ground. When the touch electrode is touched, the voltage of the output stage may become the voltage close to the input voltage (VDD). The touch circuit according to any of the embodiments shown in FIGS. 1 to 6 may be applied to the touch sensing device.

Although exemplary embodiments of the present disclosure have been described in detail, it will be understood by those skilled in the art that various changes may be made without departing from the scope of the present disclosure. Therefore, the scope of the present disclosure should not be defined as being limited to the embodiments, but should be defined by all changes and modifications that are derived from the appended claims and equivalents thereof.

1. A touch circuit for stably maintaining an output voltage level using transistors, the touch circuit comprising:
a first driving transistor (T1) having a drain electrode and a gate electrode connected to an input power supply (VDD), and having a source electrode connected to a drain electrode of a second driving transistor (T2); and
the second driving transistor (T2) having a gate electrode connected to one electrode of a capacitor, and having the drain electrode connected to the source electrode of the first driving transistor (T1), and having a source electrode connected to ground, the capacitor having another electrode connected to the input power supply (VDD).

2. A touch circuit for stably maintaining an output voltage level using transistors, the touch circuit comprising:
a first driving transistor (T1) having a drain electrode and a gate electrode connected to a source electrode of a third driving transistor (T3), and having a source electrode connected to a drain electrode of a second driving transistor (T2);
the second driving transistor (T2) having a gate electrode connected to one electrode of a capacitor, and having the drain electrode connected to the source electrode of the first driving transistor (T1), and having a source electrode connected to ground, the capacitor having another electrode connected to an input power supply (VDD);
the third driving transistor (T3) having a drain electrode and a gate electrode connected to the input power supply (VDD), and having the source electrode connected to the drain electrode of the first driving transistor (T1); and connected to a drain electrode of a fourth driving transistor (T4).
the fourth driving transistor (T4) having a gate electrode connected to the gate electrode of the second driving transistor (T2), and having a drain electrode connected to the drain electrode of the first driving transistor (T1), and having a source electrode connected to the ground.

3. The touch circuit of claim 1, further comprising:
a fifth driving transistor (T5) having a gate electrode connected to the drain electrode of the second driving transistor (T2), and having a source electrode connected to the gate electrode of the second driving transistor (T2), and having a drain electrode connected to the input power supply (VDD).

4. The touch circuit of claim 3, wherein the first driving transistor (T1) to the fourth driving transistor (T4) are N-type MOSFETs, and the fifth driving transistor (T5) is a P-type MOSFET.

5. The touch circuit of claim 1, further comprising:
a sixth driving transistor (T6) having a drain electrode connected to the gate electrode of the second driving transistor (T2), and having a gate electrode connected to the drain electrode of the second driving transistor (T2), and having a source electrode connected to the ground.

6. A touch sensing device for stably maintaining an output voltage level using transistors, the touch sensing device comprising:
a first driving transistor (T1) having a drain electrode and a gate electrode connected to an input power supply (VDD), and having a source electrode connected to a drain electrode of a second driving transistor (T2);
the second driving transistor (T2) having a gate electrode connected to one electrode of a capacitor, and having the drain electrode connected to the source electrode of the first driving transistor (T1), and having a source electrode connected to ground, the capacitor having another electrode connected to the input power supply (VDD);
a touch electrode connected to the gate electrode of the second driving transistor (T2); and
an output stage connected to the drain electrode of the second driving transistor (T2),
wherein when the touch electrode is not touched, a voltage of the output stage becomes a voltage close to the ground, or when the touch electrode is touched, the voltage of the output stage becomes a voltage close to the input power supply (VDD).

7. The touch circuit of claim 2, further comprising:
a fifth driving transistor (T5) having a gate electrode connected to the drain electrode of the second driving transistor (T2), and having a source electrode connected to the gate electrode of the second driving transistor (T2), and having a drain electrode connected to the input power supply (VDD).

8. The touch circuit of claim 7, wherein the first driving transistor (T1) to the fourth driving transistor (T4) are N-type MOSFETs, and the fifth driving transistor (T5) is a P-type MOSFET.

9. The touch circuit of claim 2, further comprising:
a sixth driving transistor (T6) having a drain electrode connected to the gate electrode of the second driving transistor (T2), and having a gate electrode connected to the drain electrode of the second driving transistor (T2), and having a source electrode connected to the ground.
